(19) United States
(12) Patent Application Publication
(10) Pub. No.: US 2016/0013572 A1
(43) Pub. Date: Jan. 14, 2016

(54) Connector

(71) Applicant: IRISO ELECTRONICS CO., LTD., Kanagawa (JP)

(72) Inventor: Hiroaki Yukutake, Kanagawa (JP)

(73) Assignee: IRISO ELECTRONICS CO., LTD., Kanagawa (JP)

(21) Appl. No.: 14/791,557

(22) Filed: Jul. 6, 2015

(30) Foreign Application Priority Data
Jul. 9, 2014 (JP) 2014-141274

(51) Int. Cl. H01R 12/71

(52) U.S. Cl. CPC H01R 12/716

(57) ABSTRACT

A through hole is provided in a housing, and a cylindrical member is inserted into the through hole so that the cylindrical member is disposed between a mating substrate and a substrate, and a screw is inserted into the cylindrical member to hold the mating substrate, the cylindrical member and the substrate. Further, the cylindrical member includes a first protruding end that protrudes from the through hole toward the mating substrate and a second protruding end that protrudes toward the substrate. Accordingly, the housing can be prevented from being pressed by the screw, and also prevented from being pressed by the mating substrate and the substrate. Therefore, the terminal can be prevented from being dropped off from the substrate due to deformation or damage of the housing.

### BACKGROUND OF THE INVENTION

1. Field of the Invention

The present invention relates to a connector for substrate-to-substrate connection which is used by being fixed to a substrate.

2. Description of the Related Art

As a connector which is used by being fixed to a substrate, a commonly used connector has a terminal which is soldered to the substrate and the housing which is fixed to the substrate by a screw. Japanese Unexamined Patent Application Publication No. 2008-159306 discloses a connector in which a substrate and a housing have a screw hole through which a screw is inserted to engage with the inner wall of the screw hole so as to fix the housing to the substrate. Further, there is also a compression type connector for substrate-to-substrate connection in which a substrate and a housing have a screw hole. In this case, the connector is fixed to one of the substrates, and then two substrates and the connector are fixed by one screw while the other substrate is in press contact with a terminal of the connector.

However, in a case where a screw is directly inserted into the screw hole of the housing to engage with the inner wall of the screw hole, there is a problem that a stress such as a tightening torque of the screw is directly applied to the housing and may cause deformation and damage. Further, in the above compression type connector, when a screw is too tightly tightened, the substrate may be strongly pressed against the terminal. In this case, there is a problem that a load is applied to a soldered portion of the terminal, causing a problem such as breakage and crack at the soldered portion, and the terminal may be dropped off from the substrate in the worst case.

### SUMMARY OF THE INVENTION

Accordingly, it is an object of the present invention to provide a connector which can be reliably fixed to a substrate without causing an excessive stress to be applied to a housing or a terminal.

According to an aspect of the present invention, a connector includes a housing mounted on a substrate, and a terminal which is fixed to the housing so that the terminal is fixed to the substrate and is in electrically conductive contact with a connection target provided on a mating substrate which opposes the substrate, wherein the housing includes a through hole, the housing further includes a cylindrical member which is housed in the through hole and disposed between the substrate and the connection target of the mating substrate, and a tightening member which is inserted into the cylindrical member and holds the cylindrical member, the substrate and the mating substrate, and the cylindrical member includes a first protruding end which is flush with a surface of the housing or protrudes from the through hole toward the connection target of the mating substrate so that the mating substrate is not in press contact with the housing, and a second protruding end which is flush with a surface of the housing or protrudes from the through hole toward the substrate so that the substrate is not in press contact with the housing.

According to the above aspect of the invention, the housing includes a through hole, the housing further includes a cylindrical member which is housed in the through hole and disposed between the substrate and the connection target of the mating substrate. The housing further includes a tightening member which is inserted into the cylindrical member and holds the cylindrical member, the substrate and the mating substrate. Since the cylindrical member which is a separate member from the housing is housed in a through hole formed on the housing and the tightening member is inserted into the cylindrical member, the cylindrical member is disposed between the tightening member and the inner wall of the through hole. Accordingly, the tightening member can hold the substrate, the mating substrate and the housing without being stuck in the inner wall of the through hole. Therefore, direct transfer of a tightening torque of the tightening member to the housing can be prevented, thereby reducing a stress applied from the tightening member to the housing.

Further, according to the above aspect of the invention, the cylindrical member includes a first protruding end which is flush with a surface of the housing or protrudes from the through hole toward the connection target of the mating substrate so that the mating substrate is not in press contact with the housing, and a second protruding end which is flush with a surface of the housing or protrudes from the through hole toward the substrate so that the substrate is not in press contact with the housing. Accordingly, a constant distance between the substrate and the connection target can be maintained, and the mating substrate and the tightening member can be maintained not to press the housing. That is, the cylindrical member can support the connection target and the substrate in a state of being apart from the housing by a protruding amount of the protruding end from the housing, or in a state of being slightly in contact to an extent that the housing is not pressed by the connection target or the substrate. Therefore, an excessive stress applied from the substrate and the mating substrate to the housing can be prevented. Further, the cylindrical member has a high rigidity to a load applied particularly in a tubular axis direction since the cylindrical member has a tubular shape. Accordingly, even if a pressure is applied from the mating substrate to the first protruding end, and a pressure is applied from the substrate to the second protruding end, the cylindrical member is not easily deformed.

The through hole has a gap between an inner wall and the cylindrical member, and the cylindrical member can be movable in the through hole in a hole axis direction. Since the through hole has the gap, a stress from the cylindrical member to the housing can be reduced compared with a case where the cylindrical member is press fitted in the through hole and the inner wall of the through hole and the cylindrical member are in press contact with each other. Further, a tightening torque of the tightening member applied to the housing can be more effectively reduced.

The through hole has a gap between an inner wall and the cylindrical member, and the cylindrical member can be movable in the through hole in a hole axis intersecting direction. Since the through hole has the gap, a stress from the cylindrical member to the housing can be more effectively reduced compared with a case where the cylindrical member is press fitted in the through hole and is in press contact with the through hole. Further, since the gap is formed to be wider in the hole axis intersecting direction, a tightening torque of the tightening member applied to the housing can be more effectively reduced.

The cylindrical member can be made of a conductive metal and allows for electric conductive connection between the substrate and the connection target of the mating substrate. Accordingly, the cylindrical member can be used as a ground terminal. Further, since the cylindrical member is made of a conductive metal, the cylindrical member having high rigidity and resistance to deformation can be provided.

The terminal may include a plurality of branched contact pieces which are in electrically conductive contact with the connection target of the mating substrate. Accordingly, even if one of the branched contact pieces is removed from the connection target, the other of the branched contact pieces can retain electric conductive contact with the connection target, since one terminal may include a plurality of contact points with the connection target. Accordingly, the connector may have improved connection reliability.

The present invention can provide a connector which reduces a stress applied from the tightening member to the housing and has improved connection reliability by providing the cylindrical member between the through hole of the housing and the tightening member. Further, the present invention can provide a connector which reduces a stress applied to the housing or the terminal and improved connection reliability by providing the cylindrical member that maintains a distance between the substrates.

### BRIEF DESCRIPTION OF THE DRAWINGS

FIG. 1 is a perspective view which shows a front, right side and top of a connector according to one embodiment.

FIG. 2 is a perspective view which shows a back, left side and top of the connector of FIG. 1.

FIG. 3 is a front view of the connector of FIG. 1.

FIG. 4 is a back view of the connector of FIG. 1.

FIG. 5 is a top view of the connector of FIG. 1.

FIG. 6 is a bottom view of the connector of FIG. 1.

FIG. 7 is a right side view of the connector of FIG. 1.

FIG. 8 is a perspective view which shows a front, right side and top of a cylindrical member of FIG. 1.

FIG. 9 is a perspective view which shows a back, left side and top of the cylindrical member of FIG. 8.

FIG. 10 is a front view of the cylindrical member of FIG. 8.

FIG. 11 is a back view of the cylindrical member of FIG. 8.

FIG. 12 is a top view of the cylindrical member of FIG. 8.

FIG. 13 is a bottom view of the cylindrical member of FIG. 8.

FIG. 14 is a right side view of the cylindrical member of FIG. 8.

FIG. 15 is a perspective view which shows a front, right side and top of a terminal of FIG. 1.

FIG. 16 is a perspective view which shows a back, left side and top of the terminal of FIG. 15.

FIG. 17 is a sectional view taken along the line XVII-XVII of FIG. 5 and an enlarged view of B section.

FIG. 18 is a sectional view taken along the line XVIII-XVIII of FIG. 17.

FIG. 19 is an explanatory view which shows that a mating substrate is temporarily fixed to the connector of FIG. 1.

FIG. 20 is an explanatory view which shows that the mating substrate, the cylindrical member and the substrate are held by a screw.

### DESCRIPTION OF THE PREFERRED EMBODIMENTS

With reference to the drawings, one embodiment of a connector according to the present invention will be described. In this embodiment, a compression type connector 1 for substrate-to-substrate connection will be described as an example. Since the right side view and the left side view of the connector 1 are laterally symmetric, the left side view is omitted. Further, since the right side view and the left side view of a cylindrical member 8 are also laterally symmetric, the left side view is omitted.

In the description of the specification, claims and drawings, a width direction along the longitudinal direction of the connector 1 shown in FIG. 1 is referred to as an X direction, a front and back direction along the short direction of the connector 1 is referred to as a Y direction, and a height direction of the connector 1 which is vertical to the substrate surface is referred to as a Z direction. Further, the top side of the connector 1 in the height direction Z is referred to as an “upper side”, the bottom side of the connector 1 is referred to as a “lower side”, a side of the connector 1 on which a terminal 2 is disposed in the front and back direction Y is referred to as a “back side”, and a side opposite to the back side is referred to as a “front side”.

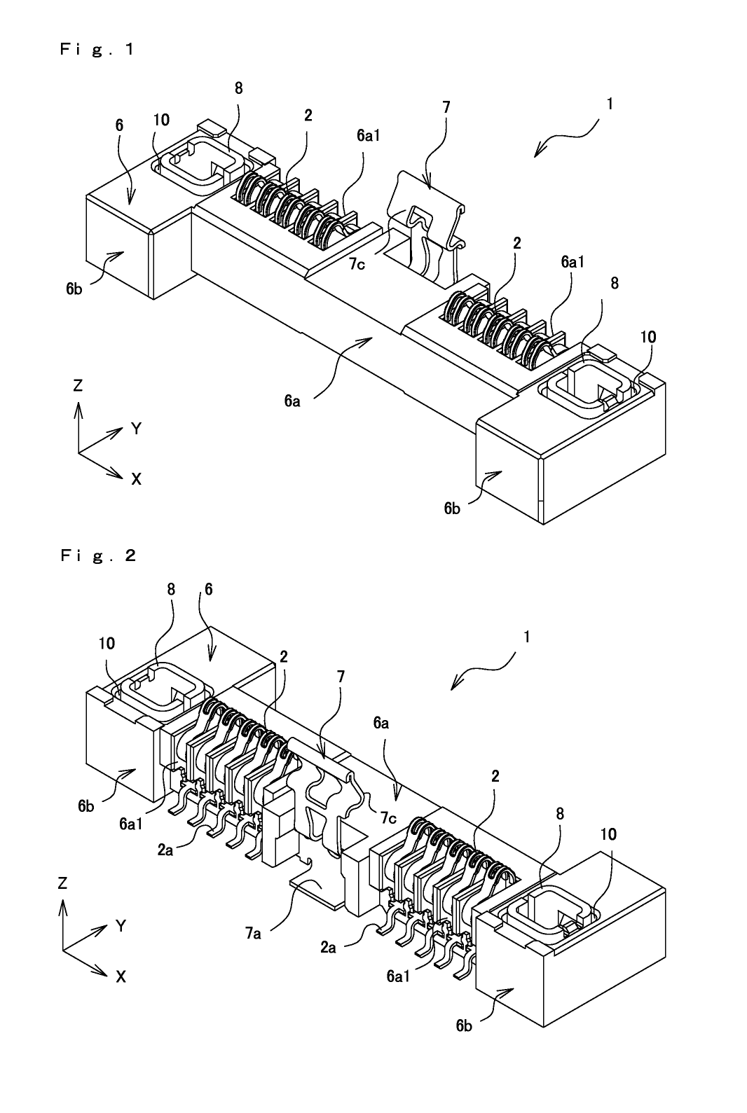

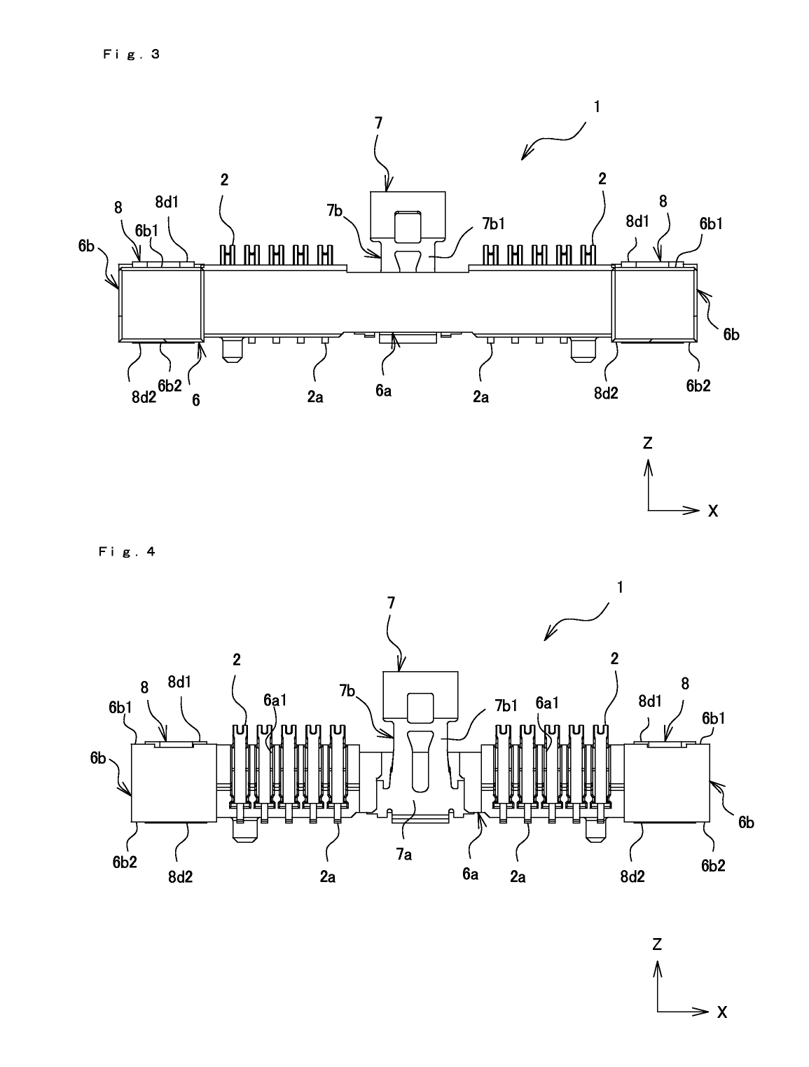

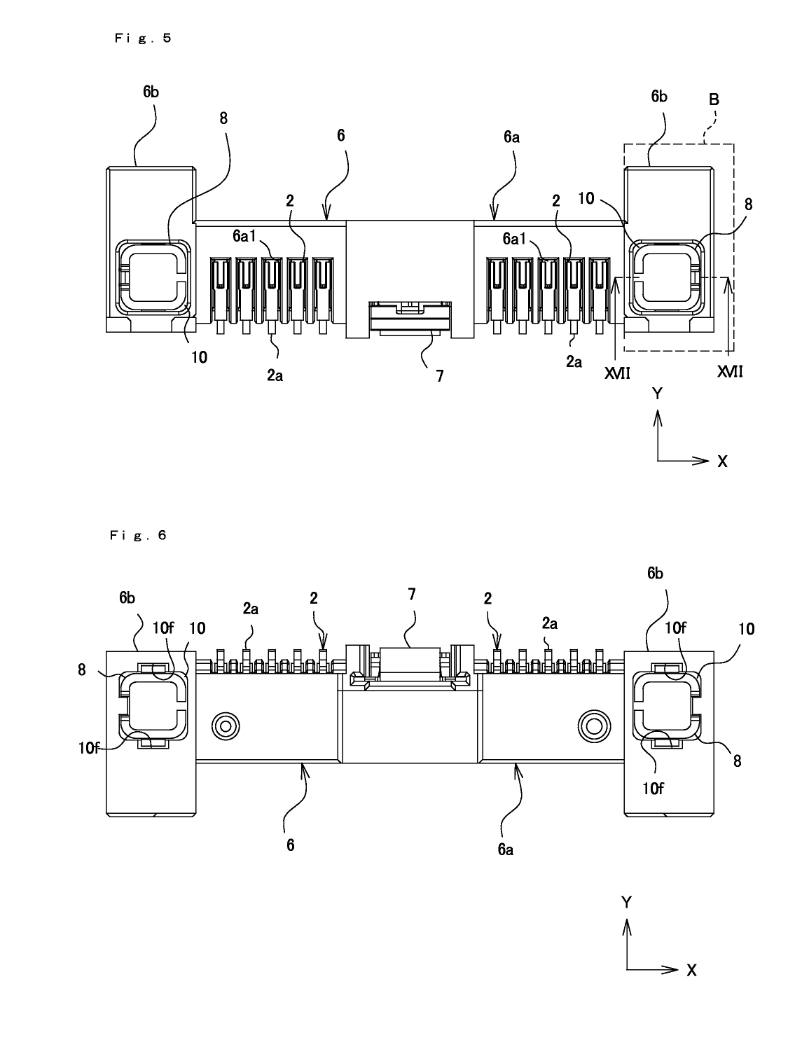

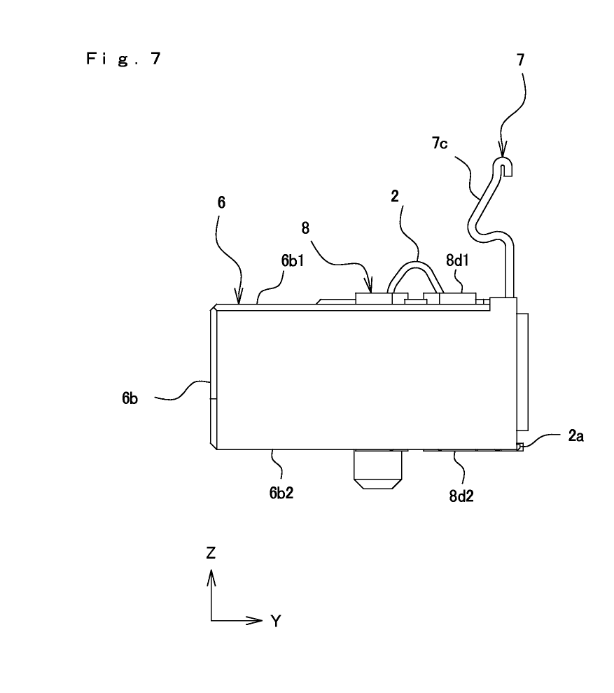

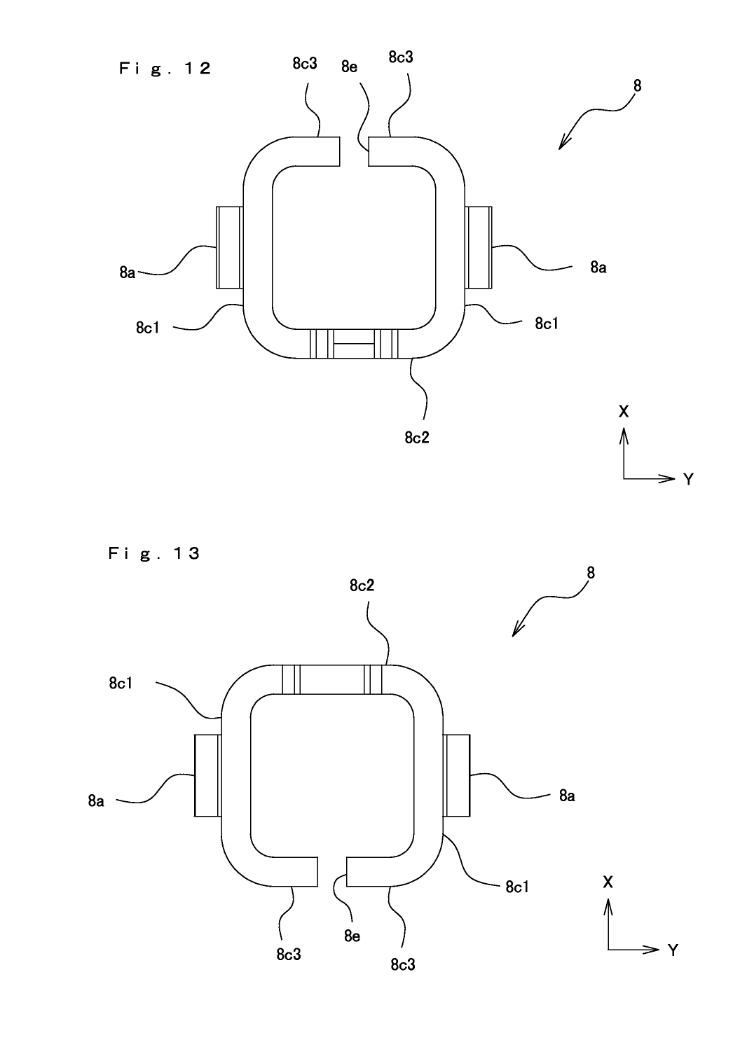

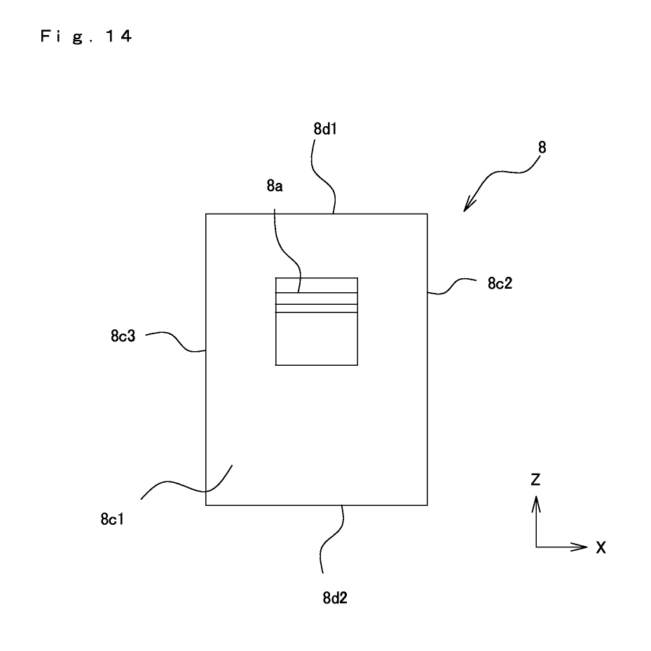

### Embodiment [FIG. 1 to FIG. 20]

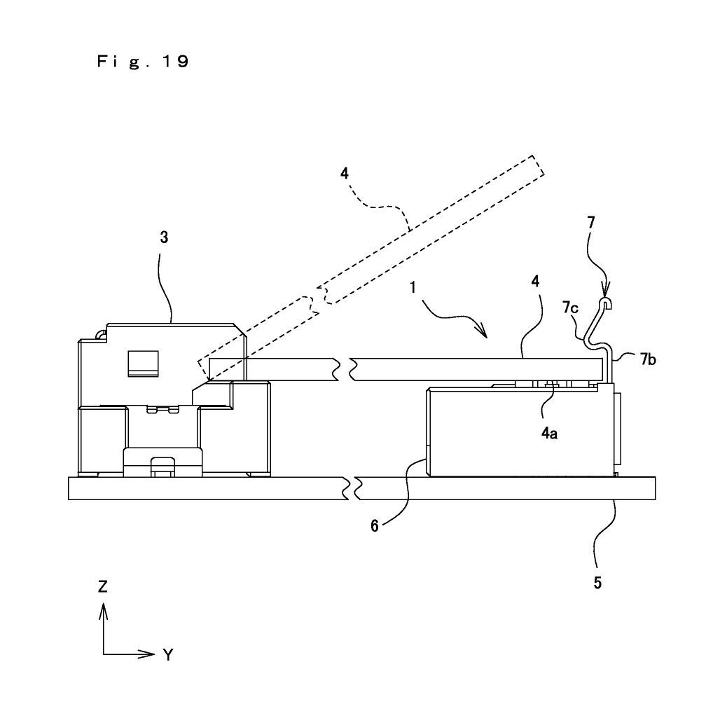

As shown in FIG. 19, the connector 1 is used in combination with an edge connector 3 to keep a mating substrate 4 to be in parallel to a substrate 5 by fixing one end of the mating substrate 4 to the edge connector 3 and the other end to the connector 1. As shown in FIGS. 1 to 7, the connector 1 includes a housing 6 mounted on the substrate 5 and terminals 2 fixed to the housing 6. The terminals 2 are fixed to the substrate 5, and are in electrically conductive contact with a connecting section 4a as a “connection target” disposed on the mating substrate 4 which faces the substrate 5. Further, a spring terminal 7 is disposed above the housing 6 so as to temporarily fix the mating substrate 4 to the housing 6.

### [Housing]

As shown in FIGS. 1 to 7, the housing 6 has a through hole 10, and includes the cylindrical member 8 housed in the through hole 10 and a screw 9 as a “tightening member” that is inserted into the cylindrical member 8 and holds the cylindrical member 8, the substrate 5 and the mating substrate 4.

The housing 6 is made of an electrically insulating resin and is formed in a substantially cuboid shape. The housing 6 includes a terminal fixation section 6a in which a plurality of terminals 2 are arranged in parallel and a mounting section 6b having the through hole 10 for housing the cylindrical member 8.

The terminal fixation section 6a has a plurality of terminal mounting grooves 6a1 along the width direction X such that each terminal 2 is fixed to the respective terminal mounting grooves 6a1. The spring terminal 7 is disposed above the terminal fixation section 6a at a substantially center in the width direction X, and the array of terminal mounting grooves 6a1 are disposed on both sides with respect to the spring terminal 7.

The mounting section 6b is disposed on each end of the terminal fixation section 6a in the width direction X and is formed to protrude forward from the terminal fixation section 6a (in a direction opposite to a side on which the terminals 2 are mounted in the front and back direction Y). Accordingly, the connector 1 can be prevented from being fallen down forward in a state of being mounted on the substrate 5, thereby being stabilized. Moreover, the connector 1 can also be prevented from being fallen down backward in a state of being mounted on the substrate 5, thereby being stabilized, since the substrate connecting sections 2a of the terminals 2, which will be described later, are fixed to the substrate 5 by soldering on the back side (a side on which the terminals 2 are mounted in the front and back direction Y). Further, the mounting section 6b is formed to protrude downwardly from the terminal fixation section 6a in the height direction Z. The mounting section 6b has the through hole 10 at the same position as the array of the terminal mounting grooves 6a1 in the front and back direction Y, and the cylindrical member 8 is housed in the through hole 10.

### [Through Hole]

The through hole 10 is formed in a substantially rectangular tubular shape and has inner walls 10a1, 10a1 which extend in the width direction X so as to face each other, an inner wall 10a2 disposed on each end side of the housing 6 in the width direction X and connected to the end of the inner walls 10a1, 10a1 and extends in the front and back direction Y, and an inner wall 10a3 disposed to face the inner wall 10a2 and connected to the end of the inner walls 10a1, 10a1 and extends in the front and back direction Y.

The inner wall 10a1 each has a housing recess 10f that houses an outward projection 8a of the cylindrical member 8, which will be described later, and an upper engagement section 10b1 that prevents the cylindrical member 8 from being dropped off.

The housing recess 10f is formed of a recess which extends from an upper end located above the distal end of the outward projection 8a when the cylindrical member 8 is housed in the through hole 10 to the lower end of the inner wall 10a1. Further, a length of the housing recess 10f in the width direction X is substantially the same as that of the outward projection 8a.

The upper engagement section 10b1 is formed on the inner wall 10a1 at a position above the housing recess 10f and on the side of the through hole 10 on which an upper opening 10c1 is located. Further, since the upper engagement sections 10b1, 10b1 are formed protruding toward each other from the inner walls 10a1, 10a1 into the inside of the through hole 10, the upper opening 10c1 of the through hole 10 has a small dimension in the front and back direction Y than the inner dimension of the through hole 10. Even if the cylindrical member 8 is upwardly displaced from the through hole 10 (toward the mating substrate 4), the outward projection 8a of the cylindrical member 8 can engage with the upper engagement section 10b1 to prevent the cylindrical member 8 from being dropped off.

The inner wall 10a2 has a lower engagement section 10b2 that prevents the cylindrical member 8 from being dropped off. The lower engagement section 10b2 is formed on the inner wall 10a2, which is disposed between the inner walls 10a1, 10a1 on each end side of the housing 6 in the width direction X, on the side of the through hole 10 on which a lower opening 10c2 is located and protrudes into the inside of the through hole 10. The lower engagement section 10b2 can engage with a recess 8b of the cylindrical member 8, which will be described later, to prevent the cylindrical member 8 from being dropped off downwardly (toward the substrate 5) from the through hole 10.

### [Cylindrical Member]

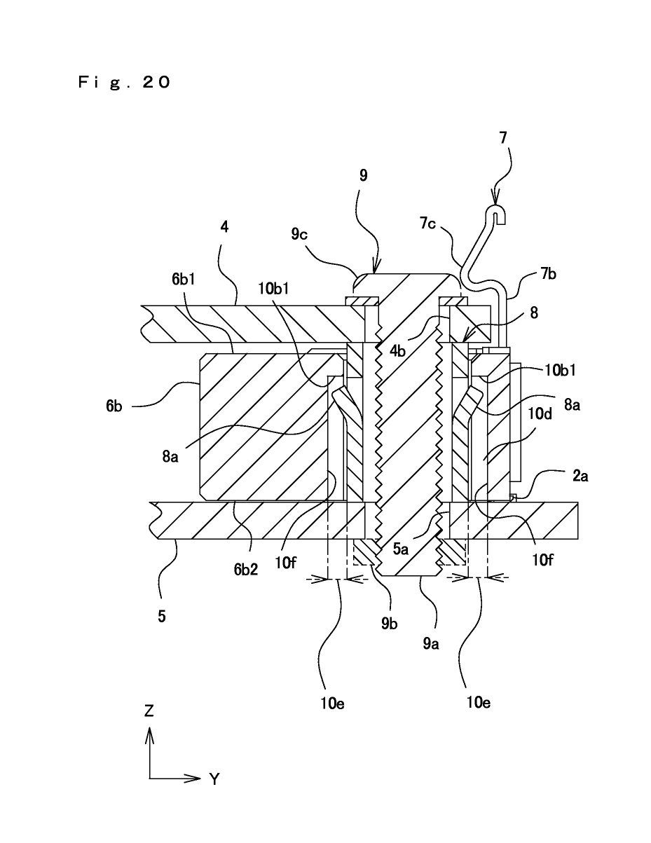

The cylindrical member 8 is formed by bending a metal sheet into a substantially rectangular tubular shape. Further, as shown in FIG. 20, the screw 9 as a “tightening member” that holds the cylindrical member 8, the substrate 5 and the mating substrate 4 is inserted into the cylindrical member 8.

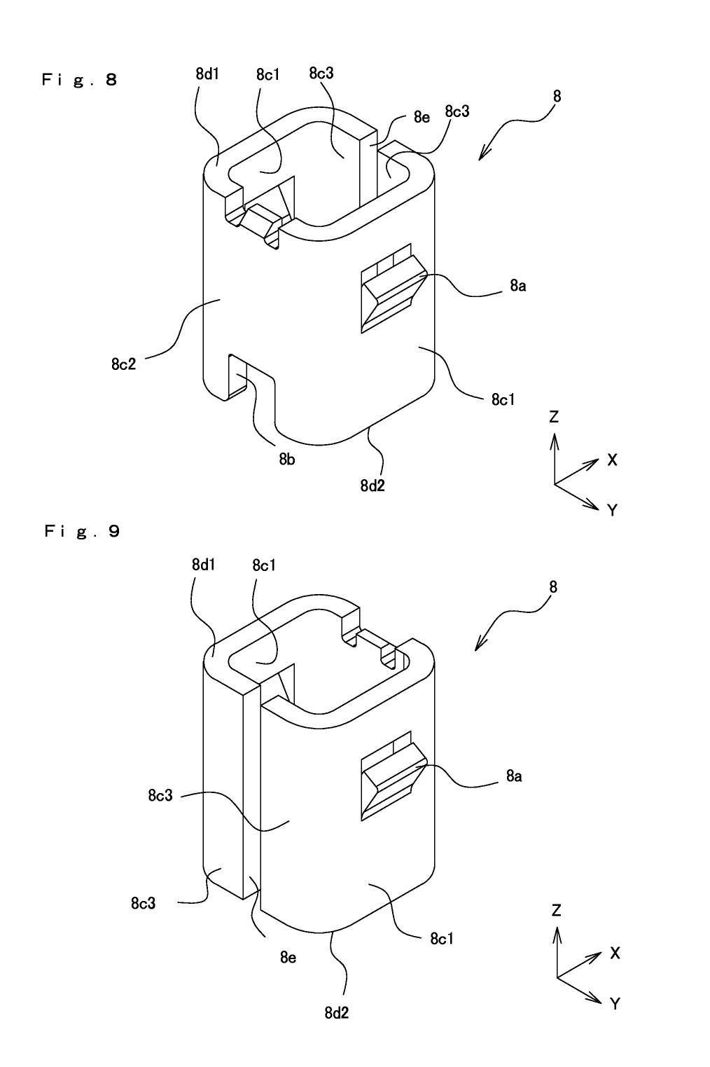

As shown in FIGS. 8 to 14, the cylindrical member 8 includes walls 8c1, 8c1 which extend in the width direction X so as to face each other, a wall 8c2 which extends in the front and back direction Y and connects the walls 8c1, 8c1, and a wall pieces 8c3, 8c3 which extend in the front and back direction Y so as to face the wall 8c2 and are each connected to an end of the walls 8c1, 8c1 on the side opposite to the wall 8c2. Further, one of the openings of the cylindrical member 8 forms a first protruding end 8d1 and the other of the openings forms a second protruding end 8d2.

The walls 8c1, 8c1 are disposed so as to face each other and have outward projections 8a, 8a, respectively, which protrude on the outside of the cylindrical member 8 toward the inner walls 10a1, 10a1 of the through hole 10 in a state of being housed in the through hole 10. Accordingly, two outward projections 8a are disposed so as to protrude in a direction apart from each other. The outward projection 8a is provided as an elastic piece in a cantilever shape which extends from an end on a side of the second protruding end 8d2 toward an end on a side of the first protruding end 8d1 in the height direction Z since it is cut and raised from the walls 8c1, 8c1 of the cylindrical member 8. When a force is applied to the cylindrical member 8 to move it upward in a state of being housed in the through hole 10, the upper ends of the outward projections 8a, 8a engage with the upper engagement sections 10b1, 10b1 of the through hole 10 as described above, thereby preventing the cylindrical member 8 from being dropped off from the upper side of the through hole 10.

The recess 8b is disposed on a lower part of the wall 6b2, and the recess 8b has an engagement end 8b1 which is an end face which extends in the width direction X and is oriented downward. The engagement end 8b1 engages with the upper end of the lower engagement section 10b2 on the inner wall 10a2 of the through hole 10 when the cylindrical member 8 is housed in the through hole 10 of the housing 6, thereby preventing the cylindrical member 8 from being dropped off from the lower side of the through hole 10.

The wall pieces 8c3, 8c3 are each connected to the ends of the walls 8c1, 8c1 and extend in the front and back direction Y. Since a slit 8e is formed between the wall pieces 8c3, 8c3, the cylindrical member 8 is open at the slit 8e and is not closed.

Since the cylindrical member 8 is made of a conductive metal and allows for electrically conductive contact between the substrate 5 and the connecting section 4a of the mating substrate 4, the cylindrical member 8 can be used as a ground terminal. Accordingly, there is no need of providing an additional member, and the ground terminal can be provided without increasing the number of components.

### [Spring Terminal]

As shown in FIGS. 1 to 5, the housing 6 includes the spring terminal 7 on the upper side. The spring terminal 7 is formed by bending a metal sheet, and includes a fixation section 7a to the housing 6, a movable section 7b which extends from the fixation section 7a and a bending section 7c disposed on the distal end of the movable section 7b.

The fixation section 7a includes a plate surface that extends along a side wall 6c of the housing 6 and engagement sections (not shown in the figure) on both ends in the width direction X. When the engagement section is press fitted into an engagement receiving section (not shown in the figure) of the housing 6, the spring terminal 7 is fixed to the housing 6.

The movable section 7b is disposed to extend upward from the fixation section 7a and has two movable pieces 7b1 having a shaft narrower than that of the fixation section 7a. These movable pieces 7b1 of a narrower shaft facilitate elastic deformation when a force is applied from the mating substrate 4.

The bending section 7c is connected to the distal end of the movable section 7b and is bent toward the front side of the housing 6. When the lower surface of the bending section 7c holds the top surface of the mating substrate 4, the mating substrate 4 can be temporarily fixed to the connector 1.

### [Terminal]

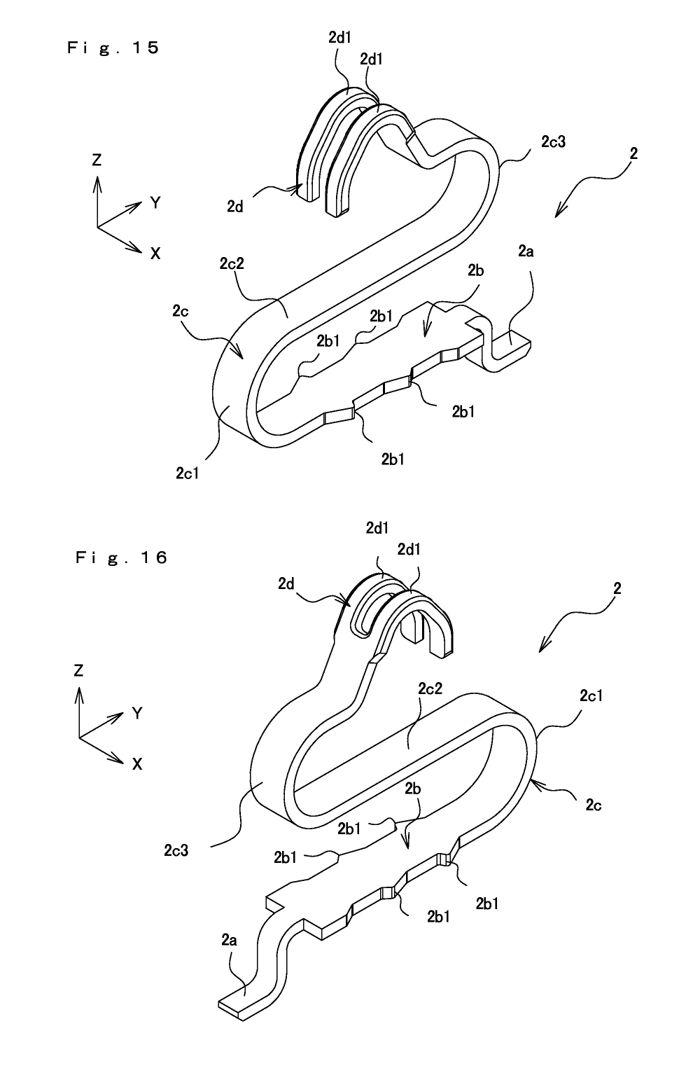

The terminal 2 is formed by bending a metal sheet. As shown in FIGS. 15 and 16, the terminal 2 includes a substrate connecting section 2a which is soldered to the substrate 5, a fixation section 2b which extends from the substrate connecting section 2a in the front and back direction Y, a movable section 2c which is connected to the fixation section 2b, and a contact section 2d which is connected to the movable section 2c and is in electrically conductive contact with the connecting section 4a of the mating substrate 4.

The plate surface of the substrate connecting section 2a is in contact with the substrate 5 and is fixed to the substrate by soldering. The substrate connecting section 2a is formed to slightly protrude downward from the mounting section 6b of the housing 6 in the height direction Z (toward the substrate 5 in the height direction Z). Accordingly, when the terminals 2 are fixed to the substrate 5, the mounting section 6b is held in a state of being lifted above the substrate 5 by a protruding length.

The fixation section 2b is connected to the substrate connecting section 2a and extends in the front and back direction Y. Further, the fixation section 2b has protrusions 2b1 at both ends in the width direction X. When the protrusions 2b1 mesh with the inside of the terminal mounting grooves 6a1 of the housing 6, the entire terminal 2 is fixed to the housing 6.

The movable section 2c has a first bending section 2c1, an extending section 2c2 and a second bending section 2c3. The first bending section 2c1 is bent backward in the front and back direction Y from the end of the fixation section 2b and is formed in a U-shape. The extending section 2c2 extends from the first bending section 2c1 in the front and back direction Y and is connected to the second bending section 2c3. The second bending section 2c3 is bent forward in the front and back direction Y and is formed in a U-shape. The end of the second bending section 2c3 is connected to the contact section 2d.

The contact section 2d has two branched contact sections 2d1, and the branched contact sections 2d1, 2d1 are each in electrically conductive contact with the connecting section 4a of the mating substrate 4. The branched contact sections 2d1, 2d1 can be independently elastically deformed. Even if one of the branched contact sections 2d1 is removed from the connecting section 4a of the mating substrate 4, the other of the branched contact sections 2d1 can retain electric conductive contact with the connecting section 4a since the terminal 2 has a plurality of branched contact sections 2d1. Accordingly, the terminal 2 may have improved connection reliability.

### [Explanation of Mounting the Cylindrical Member on the Housing]

The second protruding end 8d2 of the cylindrical member 8 is inserted into the upper opening 10c1 of the through hole 10. The outward projection 8a is formed in a cantilever shape which extends from a side of the second protruding end 8d2 to a side of the first protruding end 8d1 in the height direction Z and from inside to outside of the cylindrical member 8 in the front and back direction Y. Accordingly, when the cylindrical member 8 is inserted into the through hole 10, the outward projection 8a comes into contact with the upper engagement section 10b1 of the through hole 10. Since the outward projection 8a is formed as an elastic piece, it is pressed by the upper engagement section 10b1 of the through hole 10 and can be elastically deformed toward inside of the cylindrical member 8. Then, when the cylindrical member 8 is inserted deeper (downward) in the through hole 10 and the outward projection 8a passes by the upper engagement section 10b1 of the through hole 10, the outward projection 8a returns to the original shape by its elasticity (see FIG. 18). That is, the outward projection 8a protrudes toward outside of the cylindrical member 8 and is housed in the housing recess 10f. Then, if the cylindrical member 8 is displaced upward toward the upper opening 10c1, the outward projection 8a engages with the lower end of the upper engagement section 10b1 for preventing drop-off. Accordingly, the cylindrical member 8 can be prevented from being dropped off from the upper side of the through hole 10.

Further, although the cylindrical member 8 is formed in a substantially rectangular tubular shape, the slit 8e is disposed between the wall pieces 8c3, 8c3 as described above and the cylindrical member 8 is not completely closed. Accordingly, when the cylindrical member 8 is inserted into the above-described narrow area between the upper engagement sections 10b1, 10b1, the wall pieces 8c3, 8c3 can be elastically deformed so that their ends are brought close to each other to close the slit 8e. Since the length of the cylindrical member 8 in the front and back direction Y can be smaller than that of the original shape, the cylindrical member 8 can easily pass through the narrow upper opening 10c1 of the through hole 10.

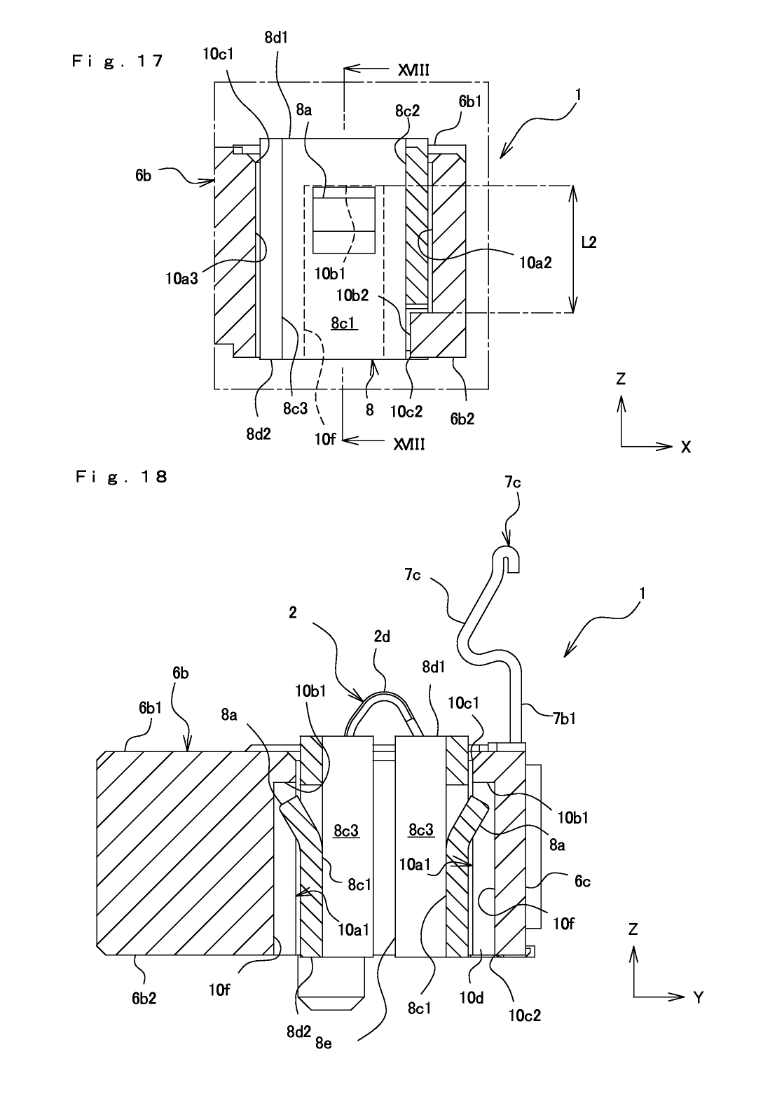

Since the engagement end 8b1 of the recess 8b is placed on the lower engagement section 10b2 of the through hole 10 due to the weight of the cylindrical member 8 inserted into the through hole 10, the cylindrical member 8 is prevented from being dropped off from the lower side of the through hole 10 (see FIG. 17).

Since the outer shape of the cylindrical member 8 is formed to be smaller than a space 10d formed by the inner walls 10a1 to 10a3 of the through hole 10, a gap 10e is provided between the cylindrical member 8 and the through hole 10 (see FIG. 20). The gap 10e has a size which allows the cylindrical member 8 to move in a hole axis intersecting direction in the through hole 10. Accordingly, compared with a case where the cylindrical member 8 is press fitted in the through hole 10 while the outer shape of the cylindrical member 8 is formed to be the same or larger than that of a space 10d of the through hole 10, a stress applied to the housing 6 from the cylindrical member 8 can be more effectively reduced. As described above, since the cylindrical member 8 is prevented from being dropped off from the through hole 10, the cylindrical member 8 is not press fitted in the through hole 10 and can be housed in the through hole 10 with the gap 10e therebetween. Accordingly, a stress applied to the housing 6 from the cylindrical member 8 can be reduced.

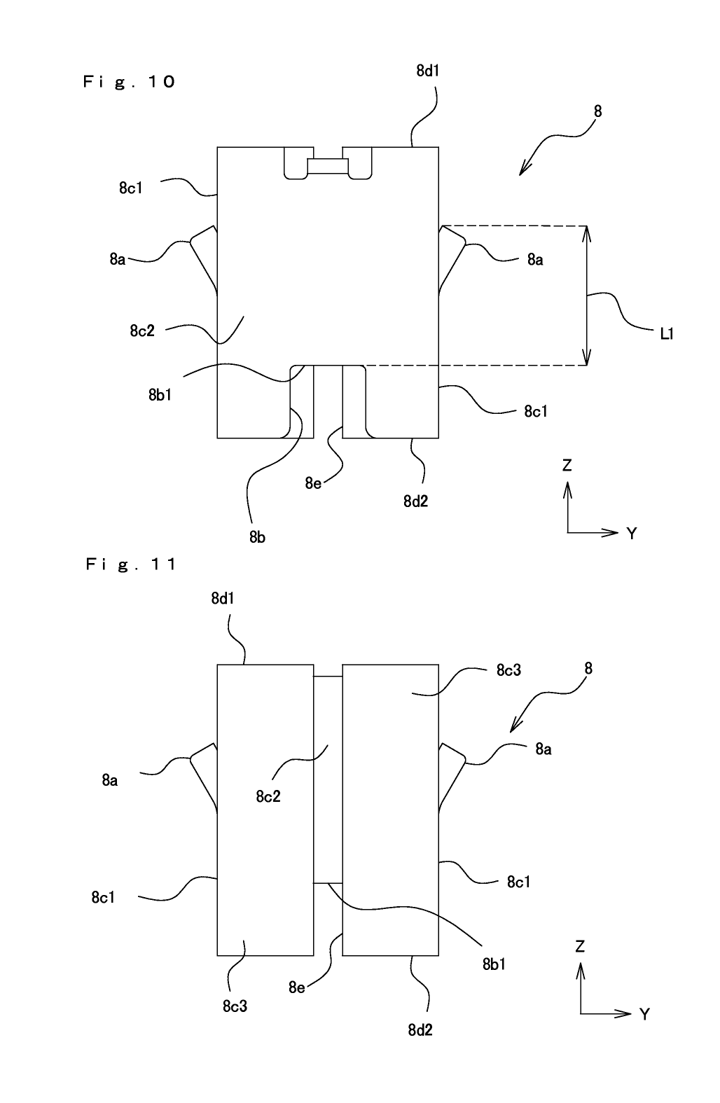

Further, a distance L2 (see FIG. 17) between the lower end of the upper engagement section 10b1 of the through hole 10 and the upper end of the lower engagement section 10b2 in the height direction Z is larger than a distance L1 (see FIG. 10) between the distal end of the outward projection 8a of the cylindrical member 8 and the engagement end 8b1 of the recess 8b in the height direction Z. Accordingly, the cylindrical member 8 is movable in the through hole 10 in the hole axis direction (height direction Z) when it is in a state of not being fixed to the substrate. When the connector 1 is in a state of being fixed to the substrate 5, the engagement end 8b1 is slightly in contact with the lower engagement section 10b2 to an extent not to press each other or is apart from the lower engagement section 10b2. Further, the outward projection 8a is also slightly in contact with the upper engagement section 10b1 to an extent not to press each other or is apart from the upper engagement section 10b1. Accordingly, a stress applied to the housing 6 from the cylindrical member 8 can be reduced.

### [Explanation of Usage]

As shown in FIG. 19, the connector 1 is placed at a position opposing the card edge connector 3 of the substrate 5, and the terminal 2 is soldered. Then, an end of the mating substrate 4 is fixed to the card edge connector 3, and the other end is turned down toward the upper part of the connector 1. In so doing, the other end of the mating substrate 4 is placed so as to press the bending section 7c of the spring terminal 7 and elastically deform the movable section 7b of the spring terminal 7 to the back side. When the other end of the mating substrate 4 is further turned down toward the housing 6, the spring terminal 7 returns to the original position by its elasticity. As described above, when the lower surface of the bending section 7c holds the top surface of the mating substrate 4, the mating substrate 4 can be temporarily fixed to the connector 1 (temporary fixed state). Thus, the connecting section 4a of the mating substrate 4 comes into contact with the branched contact sections 2d1 of the terminal 2. The other end of the mating substrate 4 is upwardly biased by an elastic force of the movable section 2c of the terminal 2, the upward displacement is restricted by the bending section 7c of the spring terminal 7 as described above. In this temporary fixed state, the connecting section 4a of the mating substrate 4 is not in contact with or slightly in contact with the first protruding end 8d1 of the cylindrical member 8, and is not in press contact with the cylindrical member 8.

As shown in FIG. 20, a screw hole 4b is formed in advance at a position which opposes the first protruding end 8d1 of the cylindrical member 8 on the mating substrate 4. Further, in the substrate 5, a screw hole 5a is formed in advance at a position which opposes the second protruding end 8d2 of the cylindrical member 8. Then, a lead portion 9a of the screw 9 is inserted into the screw hole 4b, the cylindrical member 8 and the screw hole 5a. Accordingly, the mating substrate 4, the cylindrical member 8 and the substrate 5 are held by the screw 9 and a nut 9b disposed under the substrate 5. That is, the mating substrate 4, which is biased upward by the movable section 2c of the terminal 2 and restricted so as not to be displaced upward by the spring terminal 7 (temporary fixed state), can be pressed down by a head 9c of the screw 9 toward the connector 1 so that the mating substrate 4, the cylindrical member 8 and the substrate 5 is held from both sides by the head 9c of the screw 9 and the nut 9b. In this holding state, the mating substrate 4 is pressed from above by the head 9c of the screw 9 and the contact section 2d of the terminal 2 is pressed downward. The mating substrate 4 is not in contact with the spring terminal 7. The cylindrical member 8 is formed in a substantially rectangular tubular shape, and the through hole 10 is also formed in a substantially rectangular tubular shape which is larger than the outer shape of the cylindrical member 8. Accordingly, even if the cylindrical member 8 rotates with rotation of the screw 9 in the through hole 10, such movement is restricted by the inner walls 10a1 to 10a3.

As described above, since the cylindrical member 8 which is a separate member from the housing 6 is disposed between the screw 9 and the through hole 10, the substrate 5, the mating substrate 4 and the housing 6 can be fixed while preventing the screw 9 from being stuck in the inner walls 10a1 to 10a3 of the through hole 10. Accordingly, direct transfer of a tightening torque of the screw 9 to the housing 6 can be prevented, thereby reducing a stress applied from the screw 9 to the housing 6. Further, since the through hole 10 has the gap 10e between the cylindrical member 8 and the through hole 10, transfer of a tightening torque of the screw 9 to the housing 6 can be more effectively prevented.

As shown in FIGS. 17 and 18, the cylindrical member 8 is formed to be longer than the housing 6 in the height direction Z. When the connector 1 is in a state of being fixed to the substrate 5, the first protruding end 8d1 protrudes from the through hole 10 toward the mating substrate 4. Further, in this state, the opening on the opposite side as the second protruding end 8d2 protrudes from the through hole 10 toward the substrate 5, and is disposed at a position as that of a lower end of the substrate connecting section 2a of the terminal 2 in the height direction Z. Accordingly, since the housing 6 is held in a state of being lifted above the substrate 5, and a stress applied from the substrate 5 to the substrate connecting section 2a of the terminal 2 is received by the cylindrical member 8, a stress to the substrate connecting section 2a can be reduced.

As described above, the cylindrical member 8, which is provided between the substrate 5 and the connecting section 4a of the mating substrate 4, serves as a support member that maintains an interval between two substrates 4, 5. Accordingly, a constant distance between the substrate 5 and the connecting section 4a of the mating substrate 4 can be maintained, and the mating substrate 4 and the substrate 5 can be maintained not to press the housing 6. That is, the cylindrical member 8 can support the connecting section 4a in a state of being apart from the housing 6 by a protruding amount of the first protruding end 8d1 protruding from the top surface of the housing 6, or in a state of being slightly in contact with the connecting section 4a to an extent that the housing 6 is not pressed. Further, the cylindrical member 8 can support the substrate 5 in a state of being apart from the housing 6 by a protruding amount of the second protruding end 8d2 protruding from the lower surface of the housing 6 or in a state of being slightly in contact with the substrate 5 to an extent that the housing 6 is not pressed.

Further, the cylindrical member 8 has a high rigidity to a load applied in a tubular axis direction since the cylindrical member 8 has a tubular shape. Accordingly, even if a pressure is applied from the mating substrate 4 to the first protruding end 8d1, or a pressure is applied from the substrate 5 to the second protruding end 8d2, the cylindrical member 8 is not easily deformed. Further, since the cylindrical member 8 is formed by a metal sheet, the cylindrical member 8 having high rigidity and resistance to deformation can be provided.

As described above, according to the connector 1 of the present embodiment, since the cylindrical member 8 is inserted into the through hole 10 and then the screw 9 is inserted into the cylindrical member 8, the mating substrate 4, the substrate 5 and the cylindrical member 8 can be held while preventing the screw 9 from being stuck in the inner walls 10a1 to 10a3 of the through hole 10. Accordingly, a stress to the housing 6 caused by the stuck screw 9 can be reduced. Further, since the first protruding end 8d1 of the cylindrical member 8 protrudes from the through hole 10 toward the mating substrate 4, a stress applied from the mating substrate 4 to the housing 6 can be reduced. Similarly, since the second protruding end 8d2 protrudes from the through hole 10 toward the substrate 5, a stress applied from the substrate 5 to the housing 6 can be reduced. Further, since the through hole 10 has the gap 10e between the cylindrical member 8 and the through hole 10 so as to allow the cylindrical member 8 to move, a stress applied from the cylindrical member 8 to the housing 6 can be reduced.

### Modification

In the above embodiment, an example has been described in which the connector 1 has the first protruding end 8d1 and the second protruding end 8d2 protruding from the through hole 10. However, one or both of the first protruding end 8d1 and the second protruding end 8d2 may be provided flush with a surface of the housing 6 (a top surface 6b1 or a lower surface 6b2 of the mounting section 6b). In this configuration, since the housing 6 can be slightly in contact with the substrate 5 or the mating substrate 4 to an extent of not being pressed, a stress applied to the housing 6 can be reduced. However, in this case, the lower end of the substrate connecting section 2a of the terminal 2 needs to be in the same height position as that of the housing 6 in the height direction Z. Accordingly, the lower end of the substrate connecting section 2a is prevented from protruding downward from the housing 6 and a stress is not applied from the substrate 5.

In the above embodiment, the connector 1 includes the through hole 10 formed in a substantially rectangular tubular shape and the cylindrical member 8 formed in a substantially rectangular tubular shape. However, the through hole 10 and the cylindrical member 8 can be formed in a substantially cylindrical shape in accordance with the cross sectional shape of the screw 9. In this case, the outer shape of the cylindrical member 8 is formed to be smaller than the through hole 10 so that the gap 10e is formed, thereby reducing a stress applied from the cylindrical member 8 and the screw 9 to the housing 6.

What is claimed is:

1. A connector comprising:
a housing mounted on a substrate; and
a terminal which is fixed to the housing so that the terminal is fixed to the substrate and is in electrically conductive contact with a connection target provided on a mating substrate which opposes the substrate, wherein
the housing includes a through hole,
the housing further includes a cylindrical member which is housed in the through hole and disposed between the substrate and the connection target of the mating substrate, and a tightening member which is inserted into the cylindrical member and holds the cylindrical member, the substrate and the mating substrate, and
the cylindrical member includes a first protruding end which is flush with a surface of the housing or protrudes from the through hole toward the connection target of the mating substrate so that the mating substrate is not in press contact with the housing, and a second protruding end which is flush with a surface of the housing or protrudes from the through hole toward the substrate so that the substrate is not in press contact with the housing.

2. The connector according to claim 1, wherein the through hole has a gap between an inner wall and the cylindrical member, and the cylindrical member is movable in the through hole in a hole axis direction.

3. The connector according to claim 1, wherein the through hole has a gap between an inner wall and the cylindrical member, and the cylindrical member is movable in the through hole in a hole axis intersecting direction.

4. The connector according to claim 1, wherein the cylindrical member is made of a conductive metal and allows for electric conductive connection between the substrate and the connection target of the mating substrate.

5. The connector according to claim 1, wherein the terminal includes a plurality of branched contact pieces which are in electrically conductive contact with the connection target of the mating substrate.
